(19) United States
(12) Patent Application Publication
(10) Pub. No.: US 2026/0149917 A1
(43) Pub. Date: May 28, 2026

(54) PHASING PLUG FOR IMPROVED DIRECTIVITY RESPONSE IN A COMPRESSION DRIVER

(71) Applicant: Harman International Industries, Incorporated, Stamford, CT (US)

(72) Inventors: Alexander VOISHVILLO, Simi Valley, CA (US); Sebastien Loic THONY, Woodland Hills, CA (US)

(21) Appl. No.: 18/962,256

(22) Filed: Nov. 27, 2024

(51) Int. Cl. H04R 1/34; H04R 1/30; H04R 7/12

(52) U.S. Cl. CPC H04R 1/345; H04R 1/30; H04R 7/127; H04R 2201/34; H04R 2400/13

(57) ABSTRACT

A phasing plug for a compression driver includes a body having an inlet side with a front surface and an outlet side with a rear surface, the body disposed about a central axis. A plurality of channels are formed through the body from the inlet side to the outlet side, each of the plurality of channels having an annular configuration with an entrance at the front surface, an exit at the rear surface, and a path length between the entrance and the exit. The plurality of channels have unequal path lengths such that acoustical signals traveling through the plurality of channels form a convex wavefront at the outlet side of the phasing plug.

### TECHNICAL FIELD

Embodiments relate to a phasing plug with an optimized configuration for improving the directivity response in a compression driver.

### BACKGROUND

Compression drivers generate acoustical signals, or sound waves, by a vibrating diaphragm, through a phasing plug through which the acoustical signals propagate, and to a waveguide or horn. A thin layer of air, termed a compression chamber, separates the diaphragm and the phasing plug. In general, compression drivers belong to two major categories, drivers based on dome diaphragms and drivers based on annular diaphragms. Typically, compression drivers have a circular exit matching the correspondent circular entrance of the horn. The exit of the compression driver is essentially the exit of the phasing plug, where the phasing plug acoustically connects the compression chamber and the horn.

In a compression driver, the overall area of the entrance to the phasing plug is significantly smaller than the area of the diaphragm. This is a necessary condition to increase the loading impedance for the vibrating diaphragm and, therefore, to increase the efficiency of a compression driver. The fact that the phasing plug entrance area is smaller than the area of the diaphragm increases loading impedance to provide matching of the output impedance of the vibrating diaphragm and the input impedance of the phasing plug followed by the horn or waveguide. Matched impedances provide maximum efficiency in the compression driver.

To maximize the efficiency of the compression driver, the overall entrance area of the phasing plug is typically 6-10 times smaller than the area of the diaphragm. From the standpoint of the cross-sectional area, the phasing plug can be considered as a small, short horn connecting the compression chamber with the exit of the compression driver. As in a regular horn, the cross-sectional area should gradually increase from the inlet to the outlet, such as to match the throat area of the waveguide or horn attached to the exit of the compression driver, as the opposite would create reflections and irregularity in the SPL (sound pressure level) frequency response. Therefore, the area of the phasing plug entrance should be smaller not only than the diaphragm area, but also smaller than the area of exit of the compression driver.

The diameter of the exit of the compression driver (and the throat diameter of the horn, correspondingly) determines control of the directivity of the compression driver at high frequencies. Therefore, to provide control of directivity to the highest frequency of the audio range and keep the directivity response constant, it is desirable to keep the throat diameter small. However, this constraint may contradict the requirement of the minimum exit diameter from the standpoint of the necessary expansion of the phasing plug area from its entrance to its exit.

### SUMMARY

In one or more embodiments, a phasing plug for a compression driver includes a body having an inlet side with a front surface and an outlet side with a rear surface, the body disposed about a central axis. A plurality of channels are formed through the body from the inlet side to the outlet side, each of the plurality of channels having an annular configuration with an entrance at the front surface, an exit at the rear surface, and a path length between the entrance and the exit. The plurality of channels have unequal path lengths such that acoustical signals traveling through the plurality of channels form a convex wavefront at the outlet side of the phasing plug.

In one or more embodiments, one or more of the plurality of channels are circuitous and include a curved configuration between the entrance and the exit. In one or more embodiments, for each of the plurality of channels, a radial distance from the central axis varies from the entrance to the exit. In one or more embodiments, the plurality of channels increase in path length from a first inner channel closest to the central axis to an outer channel farthest from the central axis.

In one or more embodiments, each of the plurality of channels is symmetric about the central axis. In one or more embodiments, the entrances of the plurality of channels form concentric circles about the central axis at the front surface, and the exits of the plurality of channels form concentric circles about the central axis at the rear surface. In one or more embodiments, for each of the plurality of channels, an area of the entrance is less than an area of the exit, such that a cross-sectional area of each channel increases from the entrance to the exit.

In one or more embodiments, the front surface is convex. In one or more embodiments, the rear surface is generally flat. In one or more embodiments, the body includes a front portion including the front surface, an intermediate portion adjacent to the front portion, and a rear portion adjacent to the intermediate portion and including the rear surface, the front surface including a chamfer so as to overhang the intermediate portion, the intermediate portion having a diameter that decreases in a linear, conical manner from the front portion to the rear portion, and the rear portion being generally cylindrical.

In one or more embodiments, a compression driver includes a motor assembly disposed about a central axis, and a diaphragm operably connected to the motor assembly along the central axis and having a concave side. A phasing plug is mounted to the motor assembly along the central axis adjacent to the diaphragm, the phasing plug having a body with an inlet side having a convex front surface oriented toward the concave side of the diaphragm and an outlet side having a generally flat rear surface. The phasing plug includes a plurality of annular channels formed through the body from the inlet side to the outlet side through which acoustical signals generated by the diaphragm travel. Each of the plurality of annular channels includes an entrance at the front surface, an exit at the rear surface, and a path length between the entrance and the exit. The plurality of annular channels have unequal path lengths such that the acoustical signals form a convex wavefront at the outlet side of the phasing plug.

In one or more embodiments, the motor assembly includes an annular magnet disposed between a top plate, and a pole piece positioned at a front side of the compression driver.

In one or more embodiments, a horn driver includes a compression driver including a motor assembly disposed about a central axis, and a dome diaphragm operably connected to the motor assembly along the central axis and having a concave side. A phasing plug is mounted to the motor assembly along the central axis adjacent to the diaphragm, the phasing plug having a body with an inlet side having a convex front surface oriented toward the concave side of the dome diaphragm and an outlet side having a generally flat rear surface. The phasing plug includes a plurality of annular channels formed through the body from the inlet side to the outlet side through which acoustical signals generated by the dome diaphragm travel. Each of the plurality of annular channels include an entrance at the front surface, an exit at the rear surface, and a path length between the entrance and the exit. The plurality of annular channels have unequal path lengths such that the acoustical signals form a convex wavefront at the outlet side of the phasing plug. A horn is mounted to the compression driver adjacent to the outlet side of the phasing plug.

### BRIEF DESCRIPTION OF THE DRAWINGS

FIG. 1 is a graph of coverage angle as a function of frequency illustrating the ideal directivity of a constant directivity horn for a compression driver, where θ₀ is the included angle (coverage angle) between the walls of the horn;

FIG. 2 is a graph of coverage angle as a function of frequency illustrating the directivity response of a conical horn with a finite diameter of the throat;

FIG. 3 is a graph of the far-field, on-axis SPL response of an FEA model of an exponential horn having a flat wavefront at the entrance;

FIG. 4 is a graph showing normalized SPL responses at different angles for an FEA model of an exponential horn with a flat wavefront at the entrance;

FIG. 5 is a graph showing the far-field, on-axis SPL response of an FEA model of an exponential horn having a concave wavefront at the entrance;

FIG. 6 is a graph showing normalized SPL responses at different angles for an FEA model of an exponential horn with a concave wavefront at the entrance;

FIG. 7 is a graph showing the far-field, on-axis SPL response of an FEA model of an exponential horn having a convex wavefront at the entrance;

FIG. 8 is a graph showing normalized SPL responses at different angles for an FEA model of an exponential horn with a convex wavefront at the entrance;

FIG. 9 is a graph showing the far-field, on-axis SPL response of an FEA model of an exponential horn with a four-channel phasing plug, a compression chamber, and an infinitely rigid diaphragm, where the path lengths of the phasing plug channels are equal;

FIG. 10 is a graph showing normalized SPL responses at different angles for an FEA model of an exponential horn with a four-channel phasing plug, a compression chamber, and an infinitely rigid diaphragm, where the path lengths of the phasing plug channels are equal;

FIG. 11 is a graph showing the far-field, on-axis SPL response of an FEA model of an exponential horn with a four-channel phasing plug, a compression chamber, and an infinitely rigid diaphragm, wherein the path lengths of the phasing plug channels are unequal and have been adjusted to provide a convex wavefront at the entrance and optimize directivity;

FIG. 12 is a graph showing normalized SPL responses at different angles for an FEA model of an exponential horn with a four-channel phasing plug, a compression chamber, and an infinitely rigid diaphragm, wherein the path lengths of the phasing plug channels are unequal and have been adjusted to provide a convex wavefront at the entrance and optimize directivity;

FIG. 13 is a perspective, sectional view of a phasing plug with channels of unequal path lengths according to one or more embodiments;

FIG. 14 is a cross-sectional view of the phasing plug;

FIG. 15 is a perspective view of the phasing plug illustrating the channels at the inlet side according to one or more embodiments;

FIG. 16 is a plan view of the inlet side of the phasing plug;

FIG. 17 is a perspective view of the phasing plug illustrating the channels at the outlet side according to one or more embodiments;

FIG. 18 is a plan view of the outlet side of the phasing plug;

FIG. 19 is a cross-sectional view of a horn driver according to one or more embodiments;

FIG. 20 is an exploded view of the compression driver according to one or more embodiments;

FIG. 21 is a schematic illustration of an exponential horn model with equal channel lengths and a convex wavefront; and

FIG. 22 is a schematic illustration of an exponential horn model with unequal channel lengths and a convex wavefront.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

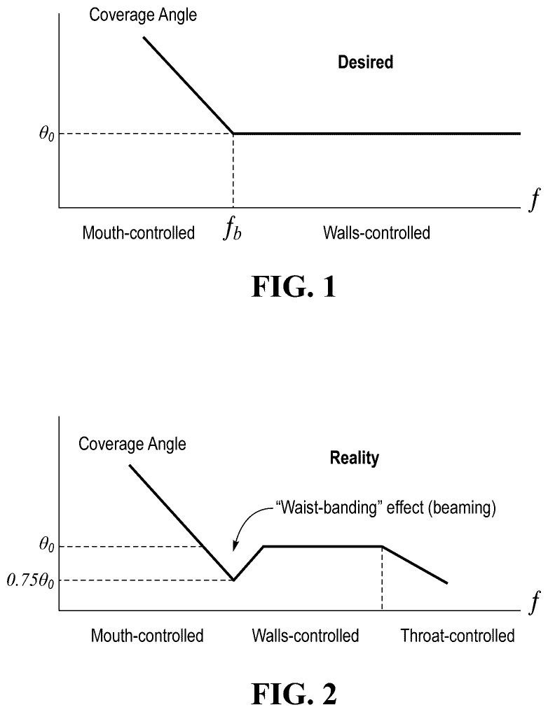

One of the ways to interpret the directivity response as a function of frequency, called beamwidth or coverage angle, is an angle from the radiation axis at which the SPL response is decreased by 6 dB. The ideal beamwidth frequency response of the constant directivity horn is shown in FIG. 1. At the frequencies below f_{b} in FIG. 1 where the wavelength is larger than the diameter of the mouth of the horn, the control of directivity is lost and the horn is omnidirectional. This graph corresponds to a hypothetical condition where the diameter of the throat of the horn (and correspondingly, of the exit of the compression driver) is much smaller than the wavelength at the highest frequency. Therefore, control of the directivity is provided through the audio frequency range.

However, in reality at least two factors influence the directivity response. FIG. 2 shows directivity corresponding to a realistic diameter of the horn throat and accounting for the fact that the horn has a conical cross-section, wherein the improvement of directivity is related to the “throat-controlled” frequency range. As shown, however, at low frequencies the directivity response is adversely affected by a “waist-banding effect”. Between the frequency range where the horn becomes non-directional and the frequency range where the directivity is controlled by the walls of the horn, the beamwidth narrows. To avoid this narrowing, special measures may be taken such as variation of the angle of the horn walls.

At high frequencies, the diameter of the horn throat controls the directivity, and the beamwidth narrows with frequency similar to the beamwidth of a piston. Therefore, to provide control of directivity to the highest frequency of the audio range and keep the directivity response constant, it is desirable to keep the throat diameter small. However, this constraint may contradict the requirement of the minimum exit diameter from the standpoint of the expansion of the phasing plug area. Typically, compression drivers utilizing a dome diaphragm have a standard exit diameter ranging from 1 inch to 2 inches, the latter belonging to compression drivers having a large diaphragm (4 inches or larger). The control of the directivity affected by the horn is lost at approximately 16 kHz (for a 1 inch exit), 12 kHz (for a 1.5 inch exit), and 8 kHz (for a 2 inch exit).

In a compression driver, the phasing plug functions to merge the acoustical signals coming from different parts of the compression chamber and to direct them to the exit of the driver. As the compression chamber is a cavity with hard walls, it exhibits acoustical resonances. Phasing plugs of compression drivers with dome diaphragms typically have multiple narrow annular slots. Positioning n annular slots at particular diameters makes it possible to suppress the first n radial resonances in the compression chamber.

In prior art phasing plugs, acoustic channels of the phasing plug typically have equal path lengths for acoustical signals to propagate from different parts of the compression chamber to an outlet of the phasing plug, thereby producing a coherent flat wavefront. The goal in such a design is for acoustical signals from each of the individual channels to arrive at the exit of the compression driver at the same time with the same phase to avoid interference, thus the name “phasing plug”.

The equality of the phases of the signals reaching the exit of the phasing plug implicates a flat wavefront. However, this condition is not optimal from the standpoint of improving directivity at high frequencies.

Accordingly, embodiments disclosed herein are directed to a phasing plug configuration that provides improved directivity response for a compression driver at high frequencies, even for compression drivers with a large diameter exit. In contrast to prior phasing plugs, the phasing plug disclosed herein has annular channels with unequal path lengths such that a progressive time delay is provided at the channel exits, resulting in a convex wavefront as will be described further below.

The following examples demonstrate the influence of the wavefront shape at the entrance of an exponential horn (exit of the compression driver) and phasing plug channel length on its directivity at high frequencies. All FEA acoustical simulations with a horn described below correspond to the 2-Pi anechoic chamber boundary condition. It is understood that the model parameters and dimensions discussed below are not intended to be limiting, but are simply selected to illustrate the different phasing plug and wavefront scenarios.

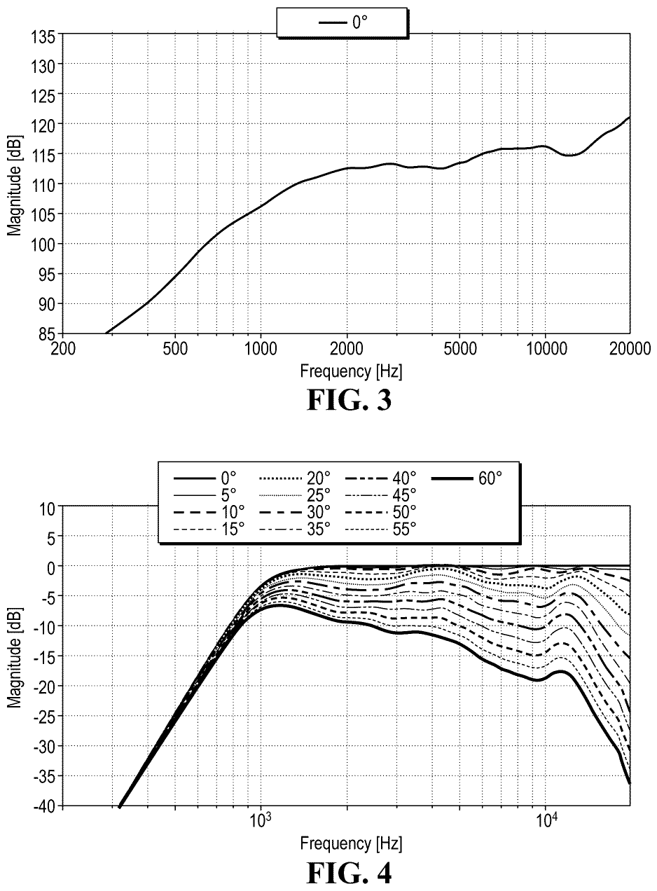

FIG. 3 is a graph showing a far-field, on-axis SPL response of an FEA model of an exponential horn having a flat wavefront at the entrance, assuming that the acoustical system is excited uniformly with a unity velocity throughout the frequency range 200 Hz-20000 Hz. In the FEA model, the diameter of the horn entrance is 38 mm, its mouth diameter is 425 mm, and its length is 267 mm. FIG. 4 is a graph showing normalized SPL responses at different angles from the axis for the FEA model of the exponential horn with a flat wavefront at the entrance, with the same model parameters as described for FIG. 3. A 4th order high-pass Butterworth filter with a 1.0 kHz cut-off is applied to the response. As illustrated, there is a strong narrowing of the directivity above 10 kHz for this flat wavefront.

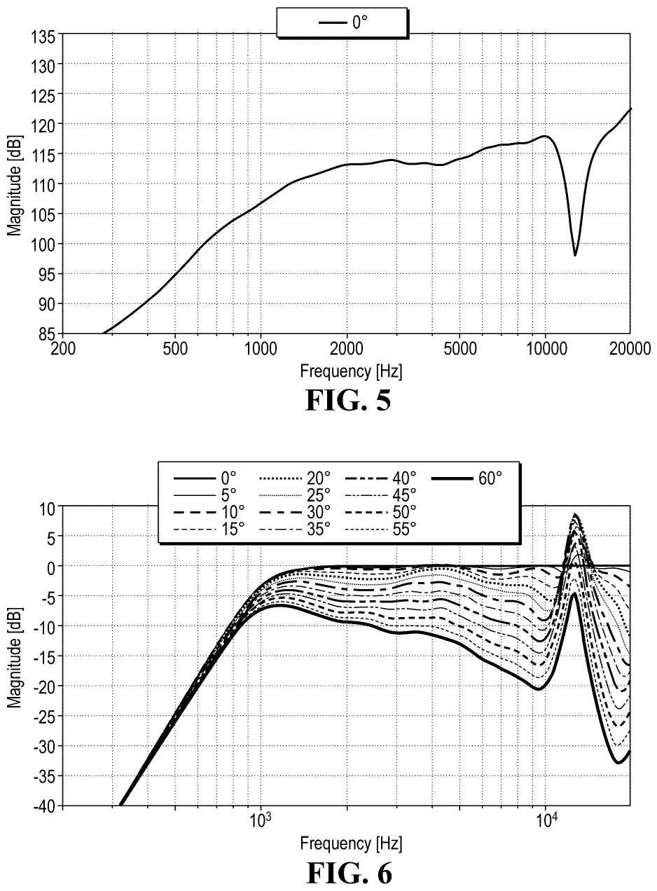

FIG. 5 is a graph showing the far-field, on-axis SPL response of an FEA model of an exponential horn having a concave wavefront at the entrance. In the FEA model, the diameter of the horn entrance is 38 mm, its mouth diameter is 425 mm, and its length is 267 mm. However, the model includes a concave wavefront, wherein the depth of the curvature is 5 mm. As shown, the concave wavefront produces a detrimental effect on the SPL response, causing a severe notch at 12 kHz. FIG. 6 shows the normalized SPL responses at different angles to the axis for the FEA model of the exponential horn having a concave wavefront at the entrance, again with the radius of the curvature arc being 5 mm. A 4th order high-pass Butterworth filter with a 1.0 kHz cut-off is applied to the response. As illustrated, the SPL response with a concave wavefront is inferior to the SPL response with a flat wavefront.

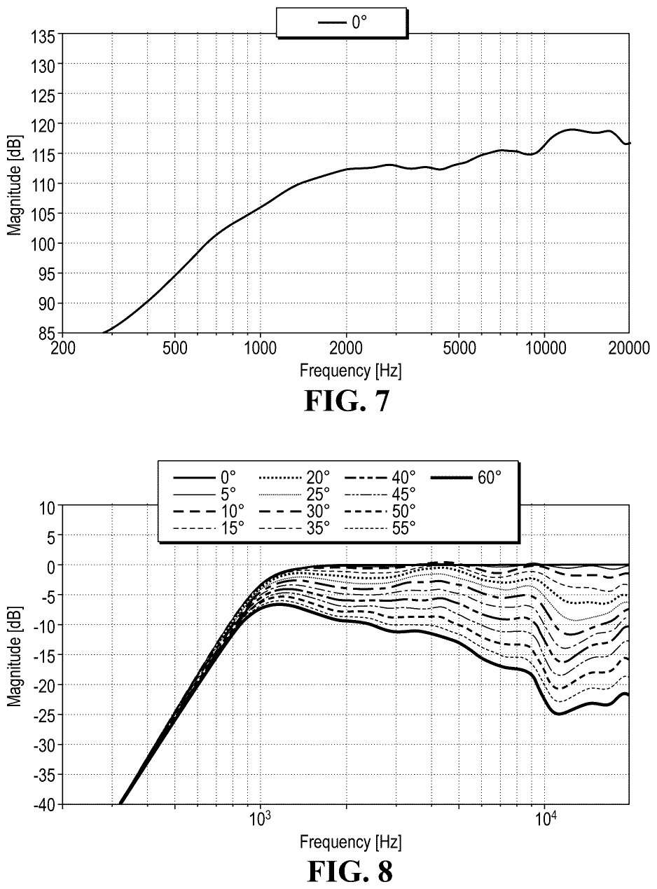

FIG. 7 is a graph showing the far-field, on-axis SPL response of an FEA model of an exponential horn having a convex wavefront at the entrance. In the FEA model, the diameter of the horn entrance is 38 mm, its mouth diameter is 425 mm, and its length is 267 mm. However, the model includes a convex wavefront, wherein the height of the convex profile is 5 mm. FIG. 8 is a graph showing normalized SPL responses at different angles to the axis for the FEA model of the exponential horn with a convex wavefront at the entrance. The height of the curvature arc is 5 mm, and a 4th order high-pass Butterworth filter with a 1.0 kHz cut-off is applied to the response. A significant improvement in the directivity response is evident with the convex wavefront as compared with the flat wavefront and the concave wavefront scenarios. As illustrated, the irregularity of the on-axis SPL response did not increase with the convex wavefront, with the exception of a slight attenuation around 20 KHz.

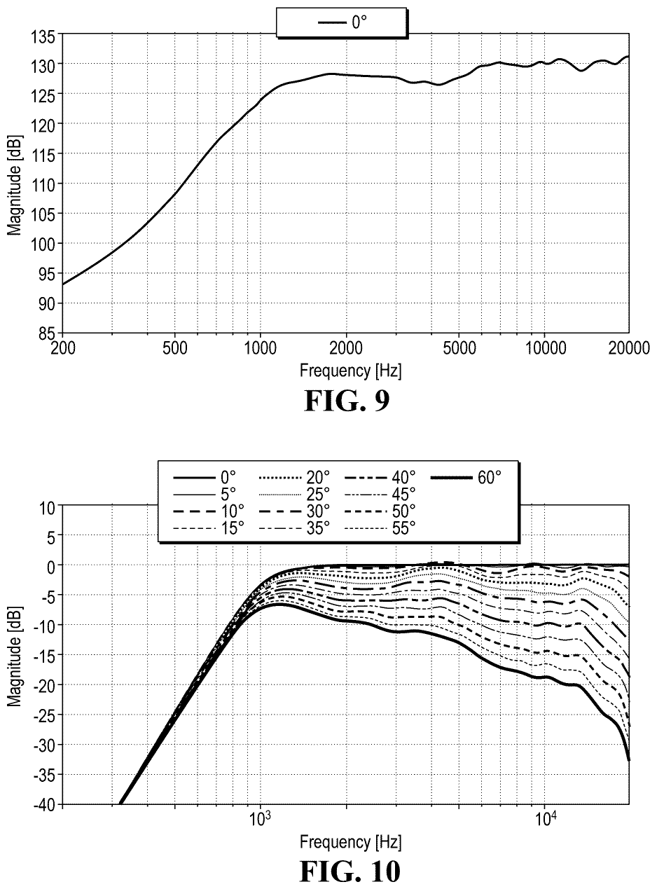

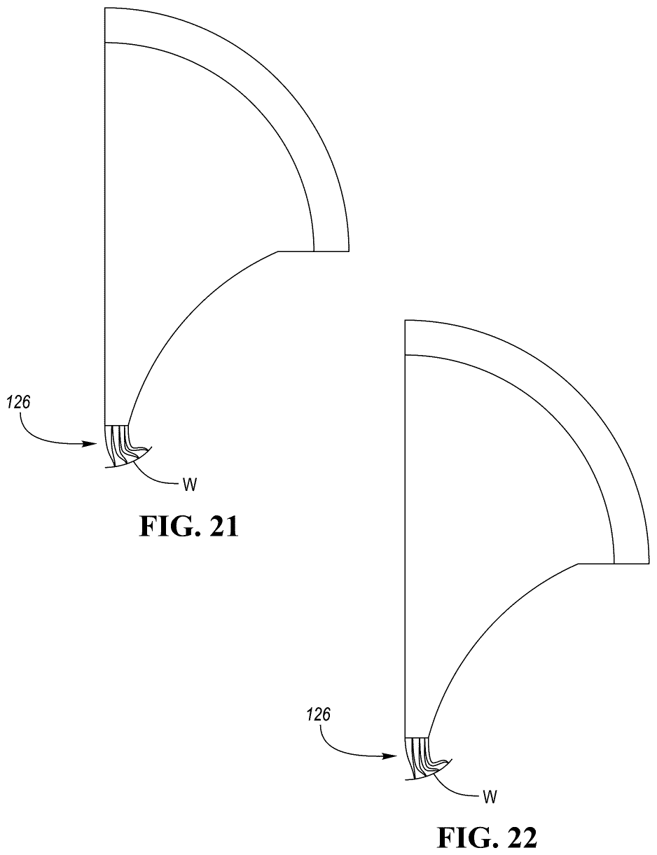

The preceding FEA models assume a continuous wavefront. In reality, however, the wavefront is not continuous, but rather discrete because of a finite number of channels in the phasing plug. Accordingly, FIG. 9 is a graph showing the far-field, on-axis SPL response of an FEA model of an exponential horn with the profile of the wavefront generated by four discrete channels, including a compression chamber and an infinite rigid diaphragm that oscillates with a unity velocity. A schematic illustration of this exponential horn model and its convex wavefront W is shown in FIG. 21. In the FEA model, the diameter of the horn entrance is 38 mm, its mouth diameter is 425 mm, and its length is 267 mm. In addition, the path lengths of the phasing plug channels are equal, and a similar acoustic signal exits all channels. FIG. 10 is a graph showing normalized SPL responses at different angles to the axis for the FEA model of FIG. 9, wherein a 4th order high-pass Butterworth filter with a 1.0 kHz cut-off is applied to the response. As shown, the directivity responses are very similar to the responses produced by the flat wavefront (FIGS. 3-4).

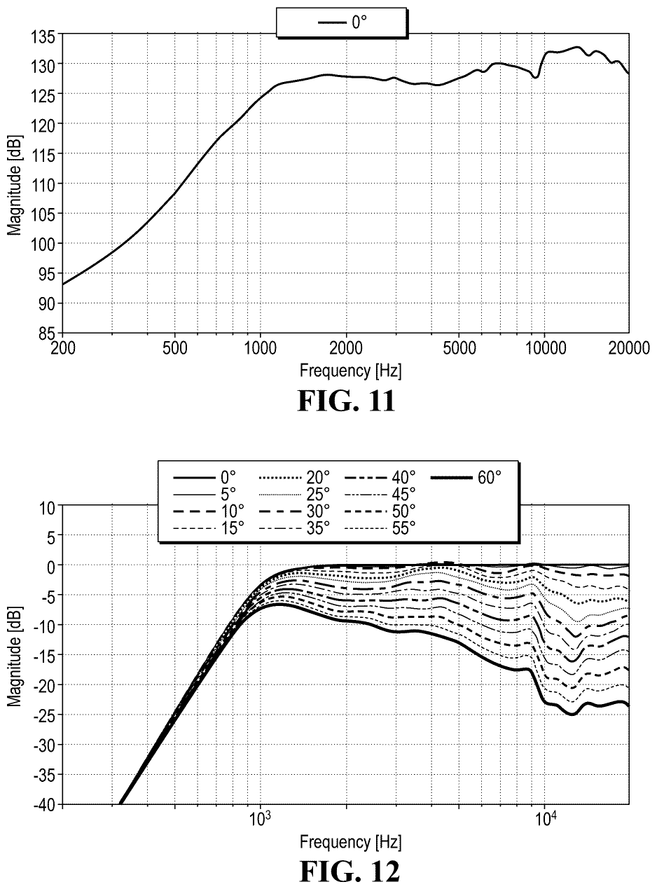

Lastly, FIG. 11 is a graph of the far-field on-axis SPL response of an FEA model of an exponential horn with a four-channel phasing plug, a compression chamber, and an infinitely rigid diaphragm that oscillates axially with a unity velocity. In the FEA model, the diameter of the horn entrance is 38 mm, its mouth diameter is 425 mm, and its length is 267 mm. However, the path lengths of the phasing plug channels have been adjusted to be unequal and to provide a convex wavefront, wherein the height of the curvature is 5 mm. In this model, the convex wavefront is created by introducing a progressive delay of 2.4 microseconds in the second (outward from the center) channel, 6.6 microseconds in the third (outward from the center) channel, and 11.8 microseconds in the outermost channel. A schematic illustration of this exponential horn model and its convex wavefront W is shown in FIG. 22. FIG. 12 is a graph showing normalized SPL responses at different angles to the axis for the FEA model of FIG. 11, wherein a 4^{th} order high-pass Butterworth filter with a 1.0 kHz cut-off is applied to the response. From a comparison of the directivity graph of FIG. 10 (channels with equal path lengths) with the graph of FIG. 12, a significant improvement and optimization of the directivity response is observed in the model with the unequal channel path lengths and convex wavefront.

With reference to the model of FIGS. 9-10, when the channel path lengths are equal (e.g. 34.2 mm each) and the entrances of the phasing plug channels are positioned in the nodes of the fourth resonance mode, the frequencies of the first four compression chamber resonances are: 4829 Hz, 8825 Hz, 12754 Hz, and 16720 Hz. The frequency of the fifth resonance is above the audio frequency range. The overall area of the inlet of the annular channels is:

$${S}_{T} = {\sum }_{i = 1}^{4} {S}_{ti} \qquad ( 1 )$$

where S_{T} is the overall area of entrances of all four annular channels.

The parameter S_{T} is calculated from the expression for the maximum efficiency of compression driver (2).

$${S}_{T} = \frac{{R}_{e} ρ {cS}_{d}^{2}}{{( B l )}^{2}} \qquad ( 2 )$$

where Rₑ is the voice coil resistance, ρ is the air density, c is the speed of sound, S_{d} is the effective area of the diaphragm, and Bl is the force factor of the driver motor.

The overall area of the phasing plug exits S_{M} is equal to the area of the nominal exit Sₒᵤₜ of the compression driver minus the area of the dividing walls S_{w} of the phasing plug:

$${S}_{M} = {S}_{out} - {S}_{w} \qquad ( 3 )$$

$${S}_{M} = {\sum }_{i = 1}^{4} {S}_{m i} \qquad ( 4 )$$

where Sₘᵢ are the exit areas of the individual channels. The areas Sₘᵢ are found from the proportionality of the entrance and exit areas:

$$\frac{{S}_{ti}}{{S}_{m i}} = const \qquad ( 5 )$$

$$\frac{{S}_{t 2}}{{S}_{t 1}} = A \frac{{S}_{t 3}}{{S}_{t 1}} = B \frac{{S}_{t 4}}{{S}_{t 1}} = C \qquad ( 6 )$$

Constants A, B, and C are found from boundary value problem solution by FEA. The profiles of the individual channels S(x) are found from the condition applied for every channel:

$$ε = \sqrt{\frac{1}{X} {{\sum }_{x = 1}^{X} [ {S}_{t} {e}^{m x} - S ( x ) ]}^{2}} = min \qquad ( 7 )$$

where Sₜe^{mx} is a profile of an exponential horn, S(x) is a value of the channel cross section along the coordinate x,

$$m = \frac{ln \frac{{S}_{m}}{{S}_{t}}}{L}$$

is the exponential horn parameter, and Lᵢ is a length of the i-th channel. For the case of the equal path length of all channels, L=34.2 mm. For the configuration of FIGS. 11-12 with the improved directivity, the optimized path lengths of the channels are then, for example, L₁=34.0 mm, L₂=34.9 mm, L₃=36.3 mm, L₄=38.1 mm.

Comparison of the aforementioned on-axis and off-axis SPL frequency responses shows significant improvement in the directivity response at high frequencies for the model of FIGS. 11-12 with unequal channel path lengths and a convex wavefront. This approach does not follow the commonly known requirement to keep the path lengths of the channels equal. While the improvement of directivity response results in a slightly increased irregularity of the SPL frequency response, a simple FIR filter may be used to equalize the irregularity of the frequency responses while still maintaining improved directivity.

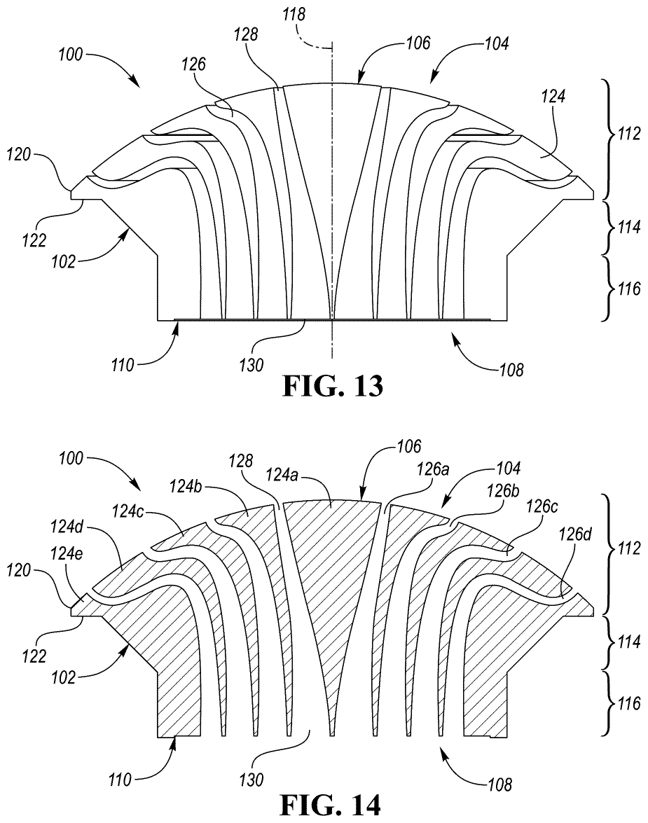

Accordingly, with reference now to FIGS. 13-20, a phasing plug 100 with unequal channel path lengths for forming a convex wavefront as in the FEA model of FIGS. 11-12 is shown for use in a compression driver 200 and in a horn driver 300.

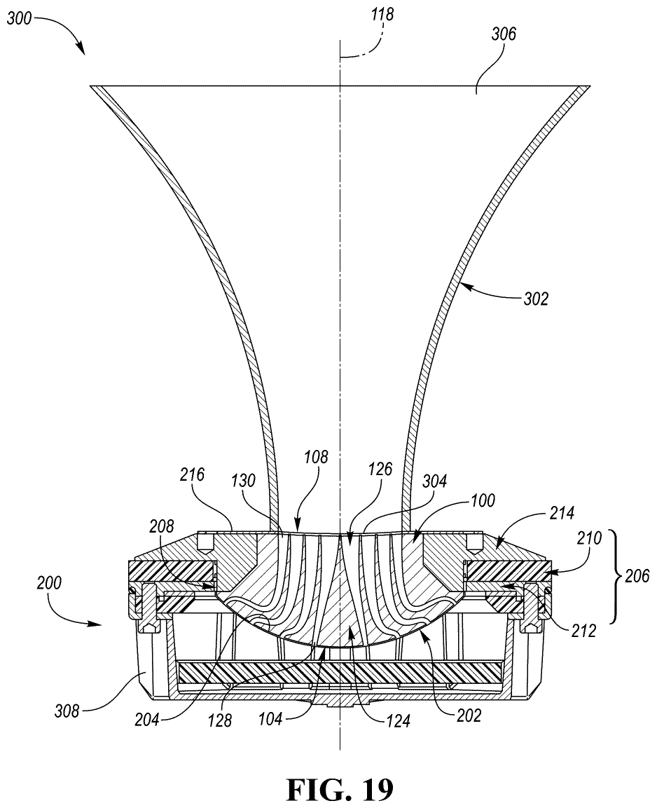

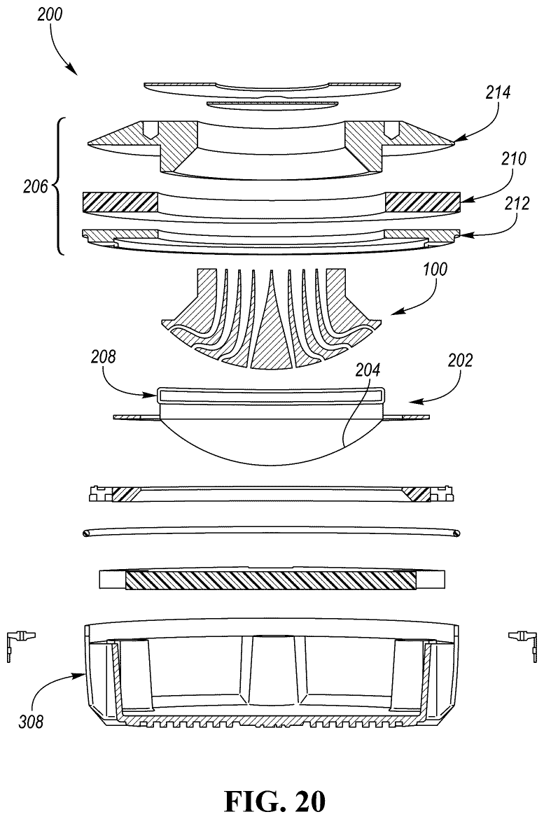

With reference first to FIGS. 13-14 and 19-20, cross-sectional views of the phasing plug 100 are illustrated. In one or more embodiments, the phasing plug 100 is configured for use in a compression driver 200 having a diaphragm 202, such as a dome diaphragm (see FIGS. 19-20), and comprises a body 102 having an inlet side 104 facing the diaphragm 202 and having a front surface 106 which may be generally convex so as to be contoured to a generally concave side 204 of the diaphragm 202. The phasing plug 100 further includes an outlet side 108 with a rear surface 110 which, in one or more embodiments, may be generally flat.

While shown and described herein with respect to a dome diaphragm 202, it is understood that the geometry of the phasing plug 100 may be tailored to virtually any diaphragm to which the phasing plug 100 may be acoustically coupled. For example, the geometry of the phasing plug 100 may be tailored to diaphragms having convex, concave, parabolic, spherical (e.g., hemispherical), conical, flat, polygonal, and other geometries.

As best illustrated in FIGS. 13-15 and 19-20, the body 102 of the phasing plug 100 may include a front portion 112, an intermediate portion 114, and a rear portion 116 formed about a central axis 118. The front portion 112 includes the front surface 106 and is generally shaped to match the shape of a diaphragm proximate which it is to be placed. In the embodiments disclosed herein, the front portion 112 is generally convex, wherein an outer perimeter 120 of the front portion 112 may include a chamfer 122. The intermediate portion 114 is formed adjacent to the front portion 112 and, in one or more embodiments, has a diameter which decreases in a linear, conical manner as the central axis 118 is traversed away from the front portion 112. The intermediate portion 114 begins at the chamfer 122, such that the intermediate portion 114 is disposed radially inward from the front portion 112, with the front portion 112 partially overhanging the intermediate portion 114. The rear portion 116 is formed adjacent to the intermediate portion 114 and may be generally cylindrical, wherein the rear portion 116 includes the rear surface 110. However, it is understood that the phasing plug 100 is not limited to this configuration, and that modifications to the dimensions and proportionality of the front portion 112, the intermediate portion 114, and the rear portion 116 of the phasing plug 100 from that depicted herein are fully contemplated.

The phasing plug 100 may be formed in various suitable manners, including the phasing plug 100 being formed as an integral body 102 or instead wherein two or more portions 112, 114, 116 of the phasing plug 100 are separately formed and subsequently joined together to form the body 102. In one or more embodiments, the phasing plug 100 may be formed from a plastic material.

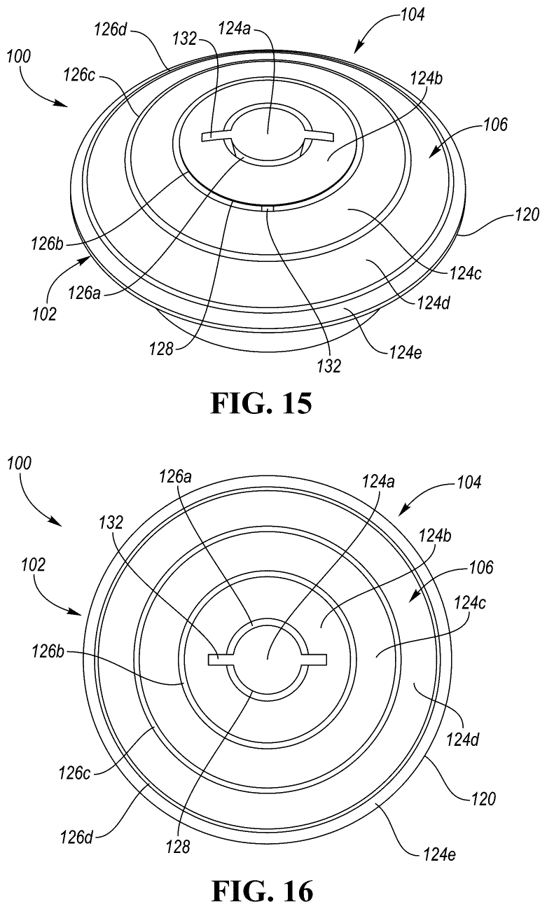

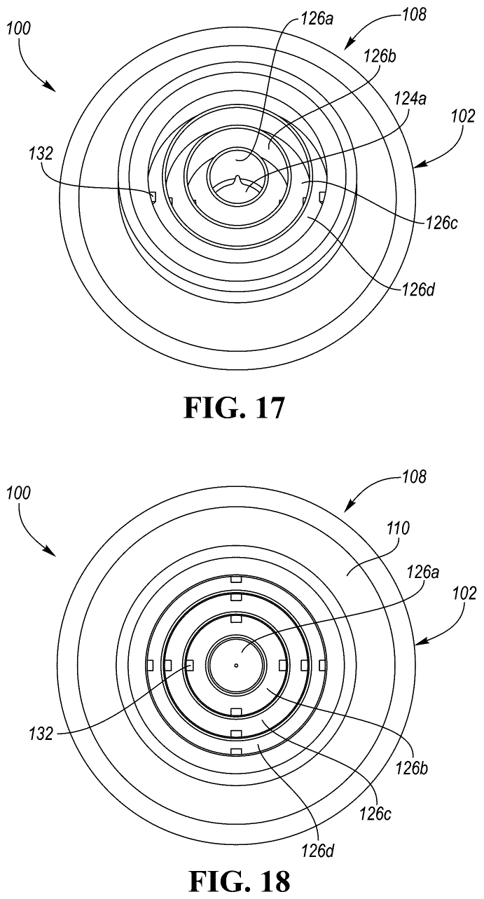

FIGS. 15-16 illustrate the inlet side 104 and the front surface 106 of the phasing plug 100 according to one or more embodiments, and FIGS. 17-18 illustrate the outlet side 108 and the rear surface 110 of the phasing plug 100 according to one or more embodiments. In the embodiments depicted herein, the phasing plug 100 includes five solid sections 124 that are at least approximately concentrically aligned with one another with respect to the central axis 118 extending from the inlet side 104 to the outlet side 108. Collectively, the sections 124 form the front surface 106 and the rear surface 110 of the phasing plug 100. Proceeding radially outward from the central axis 118, the sections 124 may comprise a central section 124a, a first inner section 124b, a second inner section 124c, a third inner section 124d, and an outer section 124c, wherein the sections 124 may decrease in height with respect to the central axis 118 from the central section 124a to the outer section 124e in a smooth, gradual manner. The outer section 124e defines the overall outer perimeter and surface of the body 102 of the phasing plug 100. It is understood that the number of sections 124 depicted herein is merely exemplary and is not intended to be limiting.

In one or more embodiments, the sections 124 are symmetric about the central axis 118. In other words, the sections 124 are symmetric across the entire diameter of the phasing plug 100 along any radial axis perpendicular to and intersecting the central axis 118. With the exception of the central section 124a which may have a generally circular cross-section, the other sections 124 may have generally annular cross-sections. However, the geometries (e.g. shape, width, spacing, etc.) of the sections 124 along the rear surface 110 may differ from their geometries at the front surface 106. As such, the geometries of the sections 124 may transition from a first geometry to a second geometry as the phasing plug 100 is traversed along the central axis 118 from the front surface 106 to the rear surface 110, respectively.

As best shown in FIGS. 13-18, adjacent sections 124a-124b, 124b-124c, 124c-124d, and 124d-124c are separated by channels 126 through which acoustical signals (sound waves) may travel. The channels 126 may be generally annular and span the length of the phasing plug 100 (e.g., as measured along the central axis 118) through the body 102 from the front surface 106 to the rear surface 110. Each channel 126 has an entrance 128 at the front surface 106 (inlet side 104) and an exit 130 at the rear surface 110 (outlet side 108) of the phasing plug 100.

In the depicted embodiment, four channels 126 may be provided, namely a first inner channel 126a, a second inner channel 126b, a third inner channel 126c, and an outer channel 126d. In one or more embodiments, the channel entrances 128 may be evenly distributed across the front surface 106 of the phasing plug 100, wherein the entrances 128 form concentric circles. In other embodiments, the spatial distribution of the channel entrances 128 at the front surface 106 may be asymmetric. In one or more embodiments, the channel exits 130 are generally circular along the rear surface 110 of the phasing plug 100, again forming concentric circles. As with the sections 124, the number of channels 126 shown is merely exemplary and is not intended to be limiting. One or more bridges 132 extending at least partially radially across the channels 126 may be provided as spacing support for the sections 124, as shown in FIGS. 17-18.

As best illustrated in FIGS. 13-14, the channels 126 have unequal path lengths according to one or more embodiments. Path length may be defined as the length of a particular channel 126 from its entrance 128 to its exit 130, or the distance that acoustical signals (sound waves) travel along that channel 126 from its entrance 128 to its exit 130. In one or more embodiments, the path length increases from the first inner channel 126a to the second inner channel 126b to the third inner channel 126c to the outer channel 126d. These unequal path lengths create a progressive delay in the acoustical signals reaching the channel exits 130 of the second inner channel 126b, the third inner channel 126c, and the outer channel 126d compared with the first inner channel 126a, with the delay of the outer channel 126d being greater than the delay of the third inner channel 126c, and the delay of the third inner channel 126c being greater than the second inner channel 126b. The unequal path lengths and progressive delay of acoustical signals reaching the channel exits 130 creates a convex wavefront at the outlet side 108 of the phasing plug 100, improving directivity at high frequencies as explained above with respect to FIGS. 11-12.

In one or more embodiments, each channel 126 is symmetric about the central axis 118. In other words, the channels 126 are symmetric across the entire diameter of the body 102 of the phasing plug 100 along any radial axis perpendicular to and intersecting the central axis 118. As the channel path length increases more for each successive channel 126 farther from the central axis 118, the channel geometries also become more circuitous and/or exhibit increasing curves or curvature for each successive channel 126 farther from the central axis 118. More specifically, with reference to FIGS. 13-14, the circuitous geometry and/or curvature of the channels 126 increases from the first inner channel 126a to the second inner channel 126b to the third inner channel 126c to the outer channel 126d. In one or more embodiments, for any given channel 126, the part of the channel 126 exhibiting the most curvature is within the front portion 112 of the body 102 of the phasing plug 100.

With reference to FIGS. 13-14 and 16, in one or more embodiments, the cross-sectional area of the channel entrances 128 may be approximately equal to each other. However, as illustrated in FIGS. 13-14, in a non-limiting embodiment, the cross-sectional area of the channel exits 130 may decrease from the first inner channel 126a to the outer channel 126d, although other configurations are also contemplated. Due to the circuitous nature of each channel 126, the exit 130 of each channel 126 may be closer to the central axis 118 than is the entrance 128 of each channel 126. Generally, the cross-sectional area of each channel 126 increases from its entrance 128 to its exit 130, such that the summed cross-sectional areas of the channel exits 130 may approximate the area of the entrance to a connected waveguide or horn 302, as described below. A quantity the channels 126 may be selected based on a number of resonances of the compression chamber that are within an audio frequency range, and entrances 128 of the channels 126 may positioned on the inlet side 104 corresponding to nodes of a highest resonance of the compression chamber within the audio frequency range.

FIG. 19 is a cross-sectional view of a horn driver 300 including a compression driver 200 according to one or more embodiments, and FIG. 20 is an exploded view of the compression driver 200 according to one or more embodiments. As shown, the compression driver 200 includes a motor assembly 206 disposed about the central axis 118, a diaphragm 202 operably connected to the motor assembly 206 along the central axis 118, and a compression chamber (not shown) disposed between the phasing plug 100 and the diaphragm 202. A voice coil 208 is mechanically connected to the diaphragm 202, such that induced motion in the voice coil 208 may be imparted to the diaphragm 202 to generate acoustical signals (sound waves). These acoustical signals are then directed to the channels 126 of the phasing plug 100 via the compression chamber, propagating from the channel entrances 128 to channel exits 130 to form a convex wavefront at the outlet side 108 of the phasing plug 100.

In the illustrated embodiment, the motor assembly 206 may include an annular magnet 210 disposed between a top plate 212 and a pole piece 214 positioned at a front side 216 of the compression driver 200. As best shown in FIG. 19, in one or more embodiments, the phasing plug 100 may be mounted to the pole piece 214, wherein the pole piece 214 may have a configuration complementary to the body 102 so as to receive the body 102 therein. The voice coil 208 may be constructed from copper, aluminum, or other current-conducting materials or combinations thereof, and the magnet 210 may be a permanent magnet comprised of hard ferromagnetic materials, including but not limited to ferrites, Neodymium alloys, alnico, or alloys thereof. It is understood that the configuration of the compression driver 200 shown and described herein is provided as an example and is not intended to be limiting.

The horn driver 300 includes a horn 302 having an expanding cross-sectional area that flares outwardly in at least one dimension from a throat 304 to a mouth 306, though other horn types are also contemplated. The throat 304 may be positioned proximate to the outlet side 108 of the phasing plug 100, allowing acoustical signals exiting the phasing plug 100 to enter the throat 304, propagate through the horn 302, and exit the horn 302 through the mouth 306. The horn driver 300 may include a rear enclosure 308 that at least partially encloses the compression driver 200 and provides a stable, fixed structure to which components of the compression driver 200 may be affixed.

In the horn driver 300, acoustical signals are directed to the horn 302 through the acoustical channels 126 of the phasing plug 100. Along their unequal path lengths, the overall cross-sectional area of the channels 126 gradually increases toward the channel exits 130 at the outlet side 108 of the phasing plug 100, at least approximately matching the area of the horn entrance (e.g., throat 304).

The phasing plug 100 disclosed herein may be utilized in a compression driver 200 and horn driver 300 to mitigate issues inherent to prior phasing plug designs with equal channel path lengths as described above. The unequal path lengths of the channels 126 and the resulting convex wavefront exiting the outlet side 108 of the phasing plug 100 and entering the horn 302 provide improved directivity at high frequencies.

It is understood that various modifications may be made to the configuration of the phasing plug 100 disclosed herein such as, but not limited to, the dimensions (e.g., width, height, length), relative placement, and curvature of the plurality of channels 126. Variations of the channel patterns and number of channels 126 disclosed herein are also fully contemplated, as is scaling and modification of the phasing plug 100, such as depending on the specific compression driver 200 and horn driver 300 into which it is incorporated.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A phasing plug for a compression driver, the phasing plug comprising:
a body including an inlet side with a front surface and an outlet side with a rear surface, the body disposed about a central axis; and
a plurality of channels formed through the body from the inlet side to the outlet side, each of the plurality of channels having an annular configuration with an entrance at the front surface, an exit at the rear surface, and a path length between the entrance and the exit, the plurality of channels having unequal path lengths such that acoustical signals traveling through the plurality of channels form a convex wavefront at the outlet side of the phasing plug.

2. The phasing plug of claim 1, wherein one or more of the plurality of channels are circuitous and include a curved configuration between the entrance and the exit.

3. The phasing plug of claim 1, wherein for each of the plurality of channels, a radial distance from the central axis varies from the entrance to the exit.

4. The phasing plug of claim 1, wherein the plurality of channels increase in path length from a first inner channel closest to the central axis to an outer channel farthest from the central axis.

5. The phasing plug of claim 1, wherein each of the plurality of channels is symmetric about the central axis.

6. The phasing plug of claim 1, wherein the entrances of the plurality of channels form concentric circles about the central axis at the front surface, and the exits of the plurality of channels form concentric circles about the central axis at the rear surface.

7. The phasing plug of claim 1, wherein for each of the plurality of channels, an area of the entrance is less than an area of the exit, such that a cross-sectional area of each channel increases from the entrance to the exit.

8. The phasing plug of claim 1, wherein the front surface is convex.

9. The phasing plug of claim 1, wherein the rear surface is generally flat.

10. The phasing plug of claim 1, wherein the body includes a front portion including the front surface, an intermediate portion adjacent to the front portion, and a rear portion adjacent to the intermediate portion and including the rear surface, the front surface including a chamfer so as to overhang the intermediate portion, the intermediate portion having a diameter that decreases in a linear, conical manner from the front portion to the rear portion, and the rear portion being generally cylindrical.

11. A compression driver, comprising:
a motor assembly disposed about a central axis;
a diaphragm operably connected to the motor assembly along the central axis and having a concave side; and
a phasing plug mounted to the motor assembly along the central axis adjacent to the diaphragm, the phasing plug having a body with an inlet side having a convex front surface oriented toward the concave side of the diaphragm and an outlet side having a generally flat rear surface, the phasing plug having a plurality of annular channels formed through the body from the inlet side to the outlet side through which acoustical signals generated by the diaphragm travel, each of the plurality of annular channels having an entrance at the front surface, an exit at the rear surface, and a path length between the entrance and the exit, the plurality of annular channels having unequal path lengths such that the acoustical signals form a convex wavefront at the outlet side of the phasing plug.

12. The compression driver of claim 11, wherein one or more of the plurality of annular channels are circuitous and include a curved configuration between the entrance and the exit.

13. The compression driver of claim 11, wherein for each of the plurality of channels, a radial distance from the central axis varies from the entrance to the exit.

14. The compression driver of claim 11, wherein the plurality of annular channels increase in path length from a first inner channel closest to the central axis to an outer channel farthest from the central axis.

15. The compression driver of claim 11, wherein each of the plurality of channels is symmetric about the central axis.

16. The compression driver of claim 11, wherein the entrances of the plurality of channels form concentric circles about the central axis at the front surface, and the exits of the plurality of channels form concentric circles about the central axis at the rear surface.

17. The compression driver of claim 11, wherein for each of the plurality of annular channels, an area of the entrance is less than an area of the exit, such that a cross-sectional area of each annular channel increases from the entrance to the exit.

18. The compression driver of claim 11, wherein the motor assembly includes an annular magnet disposed between a top plate, and a pole piece positioned at a front side of the compression driver.

19. The compression driver of claim 11, wherein the body includes a front portion including the front surface, an intermediate portion adjacent to the front portion, and a rear portion adjacent to the intermediate portion and including the rear surface, the front surface including a chamfer so as to overhang the intermediate portion, the intermediate portion having a diameter that decreases in a linear, conical manner from the front portion to the rear portion, and the rear portion being generally cylindrical.

20. A horn driver, comprising:
a compression driver including
a motor assembly disposed about a central axis,
a dome diaphragm operably connected to the motor assembly along the central axis and having a concave side, and
a phasing plug mounted to the motor assembly along the central axis adjacent to the diaphragm, the phasing plug having a body with an inlet side having a convex front surface oriented toward the concave side of the dome diaphragm and an outlet side having a generally flat rear surface, the phasing plug having a plurality of annular channels formed through the body from the inlet side to the outlet side through which acoustical signals generated by the dome diaphragm travel, each of the plurality of annular channels having an entrance at the front surface, an exit at the rear surface, and a path length between the entrance and the exit, the plurality of annular channels having unequal path lengths such that the acoustical signals form a convex wavefront at the outlet side of the phasing plug; and
a horn mounted to the compression driver adjacent to the outlet side of the phasing plug.
